(19) United States
(12) Patent Application Publication
(10) Pub. No.: US 2021/0212373 A1
(43) Pub. Date: Jul. 15, 2021

(54) ATOMIZATION ASSEMBLY AND ELECTRONIC CIGARETTE COMPRISING THE SAME

(71) Applicant: Shenzhen Eigate Technology Co., Ltd., Shenzhen (CN)

(72) Inventor: Tuanfang LIU, Shenzhen (CN)

(21) Appl. No.: 17/031,953

(22) Filed: Sep. 25, 2020

(30) Foreign Application Priority Data
Jan. 15, 2020 (CN) 202010049940.5
Jan. 15, 2020 (CN) 202020092550.1

(51) Int. Cl. A24F 40/46; A24F 40/20; H05B 1/02; H05B 3/14

(52) U.S. Cl. CPC A24F 40/46; H05B 3/141; H05B 1/0297; A24F 40/20

(57) ABSTRACT

An atomization assembly, including a stainless-steel tank and a ceramic core. The stainless-steel tank includes a side wall provided with a recess for accommodating the smoke material. The ceramic core is disposed in the stainless-steel tank and opposite to the smoke material. The ceramic core produces a heat and transmits the heat to the stainless-steel tank through heat transfer to atomize the smoke material in the stainless-steel tank to produce vapor. The stainless-steel tank includes an opening, and the vapor flows out of the opening for users to inhale.

### CROSS-REFERENCE TO RELATED APPLICATIONS

Pursuant to 35 U.S.C. § 119 and the Paris Convention Treaty, this application claims foreign priority to Chinese Patent Application No. 202010049940.5 filed Jan. 15, 2020, and to Chinese Patent Application No. 202020092550.1 filed Jan. 15, 2020. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to an atomization assembly and an electronic cigarette comprising the same.

A conventional atomization assembly comprises only one heating element. In addition, the smoke material is directly placed on the heating element of the ceramic core for vaporization. The thermal utilization rate of the heating element leaves much to be desired.

### SUMMARY

The disclosure provides an atomization assembly, comprising a stainless-steel tank and a ceramic core; the stainless-steel tank comprises a side wall provided with a recess for accommodating a smoke material; the ceramic core is disposed in the stainless-steel tank and opposite to the smoke material; the ceramic core produces and transmits heat to the stainless-steel tank through heat transfer to atomize the smoke material in the stainless-steel tank to produce vapor; the stainless-steel tank comprises an opening, and the vapor flows out of the opening for users to inhale.

In a class of this embodiment, the atomization assembly further comprises a positive contact, an insulation ring, a fixing seat, a cover, and a negative contract; the fixing seat is fixed on the top opening of the stainless-steel tank; the insulation ring is disposed on the fixing seat; the positive contact is disposed in the insulation ring to connect to a positive terminal of a power supply; the cover is disposed on the bottom end of the stainless-steel tank; the negative contract is disposed on the cover to connect to a negative terminal of the power supply.

In a class of this embodiment, the ceramic core comprises two or more heating elements disposed in parallel.

Also provided is an electronic cigarette, comprising the atomization assembly and a power control assembly; the power control assembly is disposed on one side of the atomization assembly, and comprises a battery, a power button, and a control panel; positive and negative terminals of the battery are soldered to an input end of the control panel; the control panel comprises a positive terminal of an output end connected to the positive contact of the atomization assembly, and a negative terminal of the output end connected to the negative contract to supply power to the atomization assembly to vaporize the smoke material; and the power button is disposed on the control panel to control the switch on/off of the power supply.

The atomization assembly of the disclosure comprises a stainless-steel tank and a ceramic core. The stainless-steel tank comprises a side wall provided with a recess for accommodating the smoke material. The ceramic core is disposed in the stainless-steel tank and opposite to the smoke material. The ceramic core produces and transmits heat to the stainless-steel tank through heat transfer to atomize the smoke material in the stainless-steel tank to produce vapor; the stainless-steel tank is provided with an opening, and the vapor flows out of the opening for users to inhale.

### BRIEF DESCRIPTION OF THE DRAWINGS

FIG. 1 is an exploded view of an electronic cigarette according to one embodiment of the disclosure;

FIG. 2 a schematic diagram of an electronic cigarette according to another embodiment of the disclosure; and

FIG. 3 is a sectional view of an electronic cigarette according to one embodiment of the disclosure.

### DETAILED DESCRIPTION

To further illustrate, embodiments detailing an atomization assembly and an electronic cigarette comprising the same are described below. It should be noted that the following embodiments are intended to describe and not to limit the disclosure.

Smoke materials refer to smoke oil, tobacco, tobacco and other materials used to produce smoke.

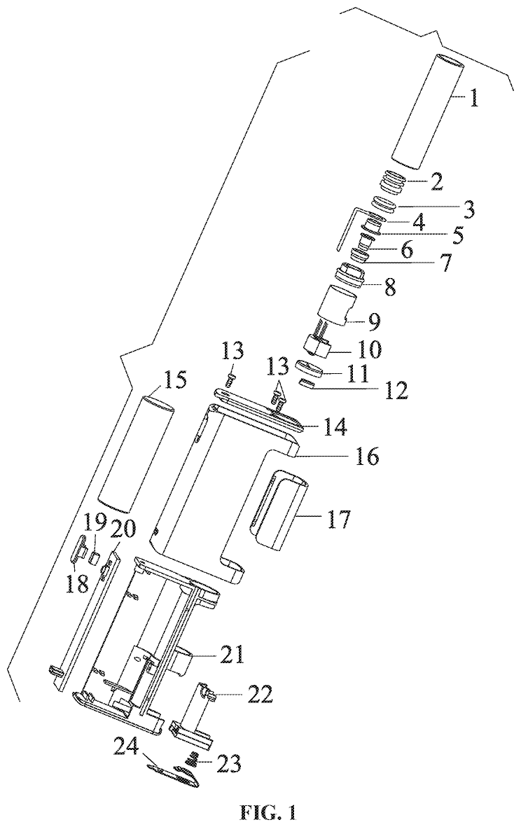

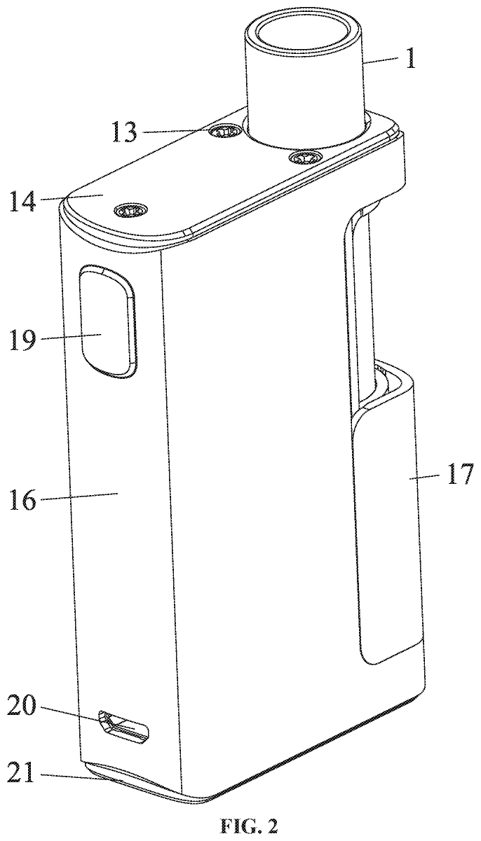

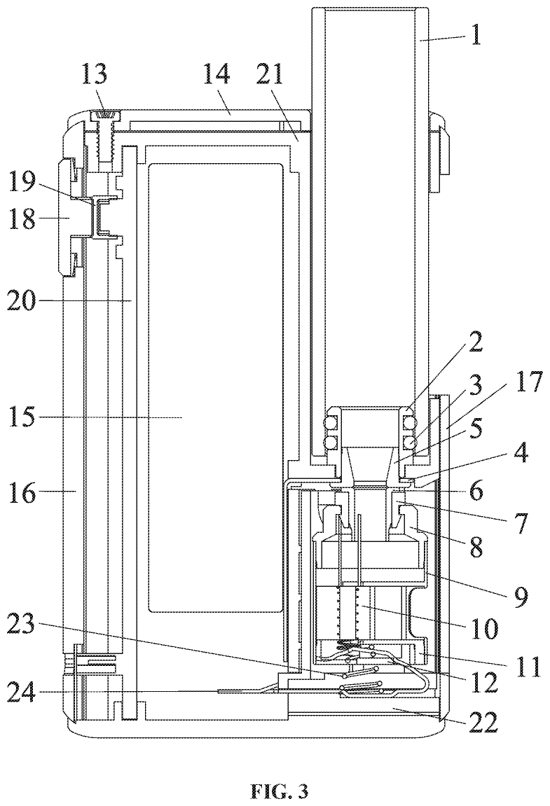

As shown in FIGS. 1-3, an electronic cigarette comprises a glass tube 1, a connector 2, a seal ring 3, a positive connecting piece 4, a first fixing part 5, a positive contact 6, an insulation ring 7, a fixing seat 8, a stainless-steel tank 9, a ceramic core 10, a cover 11, a negative contract 12, a plurality of screws 13, an upper cover 14, a battery 15, a housing 16, a protective cover 17, a power button 18, a button cap 19, a control panel 20, a support 21, a second fixing part 22, a spring 23, and a negative connecting piece 24. The stainless-steel tank 9 comprises a side wall provided with a recess for accommodating the smoke material. The ceramic core 10 is disposed in the stainless-steel tank 9 and opposite to the smoke material. The ceramic core produces and transmits heat to the stainless-steel tank through heat transfer to atomize the smoke material in the stainless-steel tank to produce vapor; the stainless-steel tank is provided with an opening, and the vapor flows out of the opening for users to inhale. The fixing seat 8 is fixed on the top opening of the stainless-steel tank 9. The insulation ring 7 is disposed on the fixing seat 8. The positive contact 6 is disposed in the insulation ring 7 to connect to the positive terminal of the power supply. The cover 11 is disposed on the bottom end of the stainless-steel tank 9. The negative contract 12 is disposed on the cover 11 to connect to the negative terminal of the power supply. The stainless-steel tank 9 is disposed in the support 21. The seal ring 3 is disposed around the connector 2 to seal the glass tube 1. The glass tube 1 is disposed on the connector 2. The positive connecting piece 4 is disposed on the first fixing part 5. The first fixing part 5 is disposed in the connector 2 and is connected to the positive contact 6. The positive and negative terminals of the battery 15 are soldered to the input end of the control panel 20. The control panel 20 and the battery 15 are disposed on the support 21. The spring 23 is disposed on the negative connecting piece 24. The negative connecting piece 24 is disposed on the second fixing part 22. The second fixing part 22 is disposed on the support 21. The positive terminal of the output end of the control panel 20 is soldered on the positive connecting piece 4 which is connected to the positive contact 6 of the atomization assembly, and the negative terminal of the output end is soldered on the negative connecting piece 24 connected to the negative contract 12 to supply power to the atomization assembly to vaporize the smoke material. The power button 18 and the button cap 19 are disposed on the control panel 20 to control the switch on/off of the power supply. The support 21 is disposed in the housing 16. The upper cover 14 is disposed on the housing and fixed by the plurality of screws 13. The protective cover 17 is disposed on the housing to protect the atomization assembly.

Spherically, the positive contact 6, the insulation ring 7, the fixing seat 8, the stainless-steel tank 9, the ceramic core 10, the cover 11, and the negative contract 12 form the atomization assembly. The battery 15, the power button 18, and the control panel 20 form a power control assembly.

It will be obvious to those skilled in the art that changes and modifications may be made, and therefore, the aim in the appended claims is to cover all such changes and modifications.

What is claimed is:

1. An atomization assembly, comprising a stainless-steel tank and a ceramic core; wherein the stainless-steel tank comprises a side wall provided with a recess for accommodating a smoke material; the ceramic core is disposed in the stainless-steel tank and opposite to the smoke material; the ceramic core produces and transmits heat to the stainless-steel tank through heat transfer to atomize the smoke material in the stainless-steel tank to produce vapor; the stainless-steel tank comprises an opening, and the vapor flows out of the opening for users to inhale.

2. The atomization assembly of claim 1, further comprising a positive contact, an insulation ring, a fixing seat, a cover, and a negative contract; wherein the fixing seat is fixed on a top opening of the stainless-steel tank; the insulation ring is disposed on the fixing seat; the positive contact is disposed in the insulation ring to connect to a positive terminal of a power supply; the cover is disposed on a bottom end of the stainless-steel tank; the negative contract is disposed on the cover to connect to a negative terminal of the power supply.

3. The atomization assembly of claim 2, wherein the ceramic core comprises two or more heating elements disposed in parallel.

4. An electronic cigarette, comprising the atomization assembly of claim 1 and a power control assembly; wherein the power control assembly is disposed on one side of the atomization assembly, and comprises a battery, a power button, and a control panel; positive and negative terminals of the battery are soldered to an input end of the control panel; the control panel comprises a positive terminal of an output end soldered on a positive connecting piece connected to a positive contact, and a negative terminal of the output end soldered on the negative connecting piece connected to a negative contract to supply power to the atomization assembly to vaporize the smoke material; and the power button is disposed on the control panel to control the switch on/off of the power supply.
